(19) United States
(12) Patent Application Publication
(10) Pub. No.: US 2015/0097511 A1
(43) Pub. Date: Apr. 9, 2015

(54) Ceiling Fan Motor With A Switch Device For Controlling Rotation Speed And Direction Of The Ceiling Fan Motor

(71) Applicant: Chin-Hsiung CHANG, Taichung City (TW)

(72) Inventor: Chin-Hsiung CHANG, Taichung City (TW)

(21) Appl. No.: 14/045,761

(22) Filed: Oct. 3, 2013

(51) Int. Cl. H02K 11/00; H02P 25/04; H02P 23/00

(52) U.S. Cl. CPC H02K 11/0063; H02P 23/0072; H02P 25/04
USPC 318/749

(57) ABSTRACT

A ceiling fan motor with a switch device for controlling rotation speed and direction includes a motor starting capacitor, a multi-stage switch and an AC power source. The motor has a main coil and a secondary coil. The motor starting capacitor is electrically connected between the main and secondary coils. The multi-stage switch includes a common contact, at least one rotation speed contact electrically connected to a second main contact of the main coil, a rotation direction contact electrically connected to a second secondary contact of the secondary coil, and a conductive member having a first conductive end electrically connected to the common contact and a second conducive end electrically connected to the rotation speed or direction contact. The motor starting capacitor cooperates with the multi-stage switch to control rotation speed and direction of the ceiling fan without requiring the use of a rotation direction switch or remoter controller.

### BACKGROUND OF THE INVENTION

1. Field of the Invention

The present invention relates to a ceiling fan, and more particularly to a ceiling fan motor with a switch device for controlling rotation speed and direction of the ceiling fan motor.

2. Description of the Prior Art

As shown in FIG. 1, a conventional ceiling fan is provided with a switch box 12 below a motor 11 to which the fan blades are fixed. In the switch box 12 is disposed a pull switch 13, and a bead chain 14 hanging down from the switch box 12 is fixed to the pull switch 13 for manually controlling the switch. On the switch box 12 is further disposed a rotation direction switch 15 for controlling the rotation direction of the motor 11.

FIG. 2 is a circuit diagram of the ceiling fan, wherein the pull switch includes three rotation speed contacts 131, 132. Between the two rotation speed contacts 131 and the main coil 111 of the motor 11 are disposed two variable capacitors 16 for controlling rotation speed. The current directions of the main coil 111 and the secondary coil 112 of the motor 11 are controlled by the rotation direction switch 15. Between the main coil 111 and the rotation direction switch 15 is electrically connected a motor starting capacitor 17 which produces current and phase difference between the main coil 111 and the secondary coil 112 to make the ceiling fan rotate.

However, the ceiling fan must be provided with the rotation direction switch 15 in order to be able to rotate reversely, and the rotation direction switch 15 includes at least four contacts 151, which not only increases the component cost of the ceiling fan, but also increases the assembling cost since it has to arrange cables for the contacts 151.

Furthermore, the ceiling fan is normally mounted at a high position where is out of the user's reach, therefore, the rotation direction switch 15 is nothing but an empty shell. To solve the problem, the ceiling fan should be provided with a remote receiver (not shown) which is electrically connected to the main coil 111 and the secondary coil 112 of the motor 11, then a remote controller (not shown) is used to start the motor 11 and control the rotation direction of the motor 11, so that the cost is further increased.

The present invention has arisen to mitigate and/or obviate the afore-described disadvantages.

### SUMMARY OF THE INVENTION

The primary objective of the present invention is to provide a ceiling fan motor with a switch device for controlling rotation speed and direction of the ceiling fan motor, which is capable of controlling rotation speed and direction of the ceiling fan without requiring the use of a rotation direction switch or a remoter controller.

Another objective of the present invention is to provide a ceiling fan motor with a switch device for controlling rotation speed and direction of the ceiling fan motor, which is capable of reducing manufacturing and assembly cost.

To achieve the above objectives, a ceiling fan motor with a switch device for controlling rotation speed and direction of the ceiling fan motor, comprises: a motor with a main coil and a secondary coil, the main coil including a first main contact and a second main contact, the secondary coil including a first secondary contact and a second secondary contact which are electrically connected to the first main contact; a motor starting capacitor electrically connected between the main coil and the secondary coil; a multi-stage switch including a common contact, at least one rotation speed contact electrically connected to the second main contact, a rotation direction contact electrically connected to the second secondary contact, and a conductive member, the conductive member including a first conductive end electrically connected to the common contact, and a second conducive end electrically connected to the rotation speed contact or the rotation direction contact or not electrically connected to the rotation speed contact or the rotation direction contact. The motor starting capacitor cooperates with the multi-stage switch to control the rotation speed and direction of the ceiling fan.

Preferably, the multi-stage switch includes three rotation speed contacts electrically connected to the second main contact, between each of two of the three rotation speed contacts and the second main contact is electrically connected a variable capacitor, and the two capacitor are different in capacitance.

Preferably, it further comprises an alternative current power source which has a first electrode electrically connected to the first main contact and a second electrode electrically connected to the common contact.

### BRIEF DESCRIPTION OF THE DRAWINGS

FIG. 1 shows a conventional ceiling fan;

FIG. 2 is a circuit diagram of the conventional ceiling fan;

FIG. 3 is a circuit diagram of a ceiling fan motor with a switch device for controlling rotation speed and direction of the ceiling fan motor in accordance with a first embodiment of the present invention;

FIG. 4 is a circuit diagram of the first embodiment of the present invention, wherein the second conductive end of the conductive member is electrically connected to the third rotation speed contact to make the motor rotate in forward direction;

FIG. 5 is a circuit diagram of the first embodiment of the present invention, wherein the second conductive end of the conductive member is electrically connected to the rotation direction contact to make the motor rotate in reverse direction; and

FIG. 6 is a circuit diagram of a ceiling fan motor with a switch device for controlling rotation speed and direction of the ceiling fan motor in accordance with a second embodiment of the present invention.

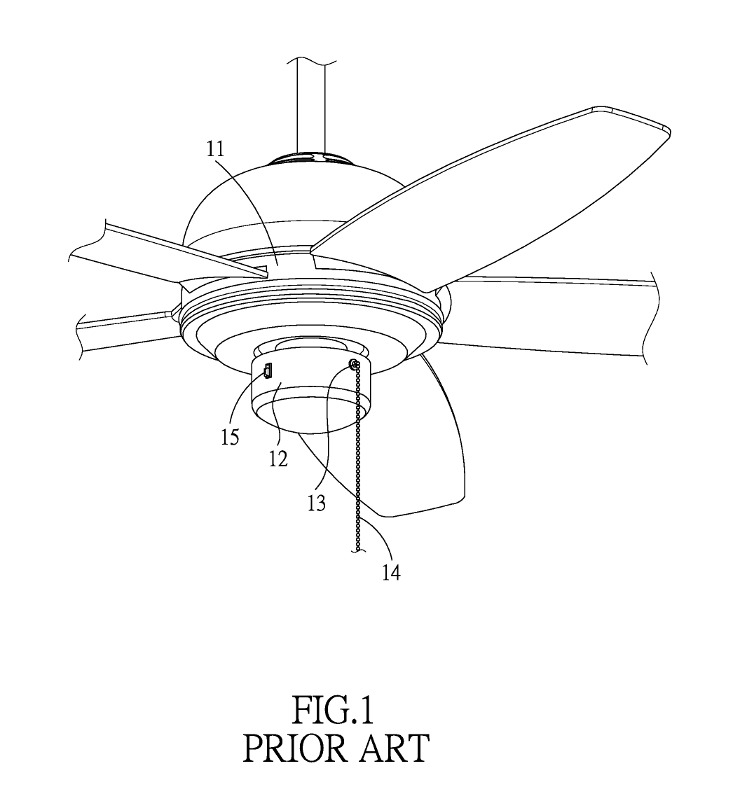

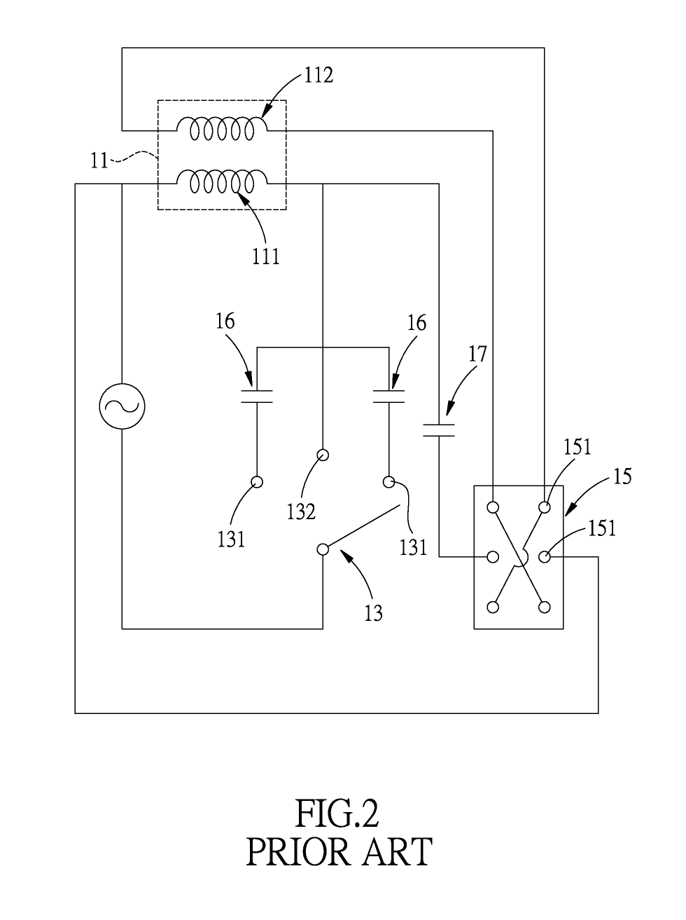

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

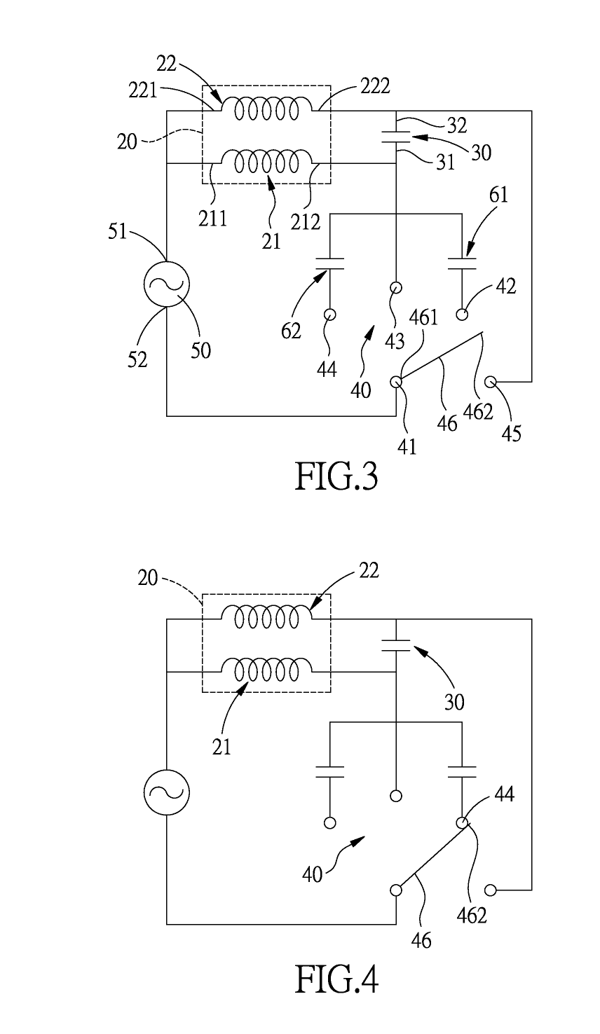

Referring to FIG. 3, a ceiling fan motor with a switch device for controlling rotation speed and direction of the ceiling fan motor in accordance with a first embodiment of the present invention comprises: a motor 20, a motor starting capacitor 30, a multi-stage switch 40 and an AC (alternative current) power source 50.

The motor 20 includes a main coil 21 for effecting rotation of the inner rotor, and a secondary coil 22. The main coil 21 includes a first main contact 211 and a second main contact 212. The secondary coil 22 includes a first secondary contact 221 and a second secondary contact 222 which are electrically connected to the first main contact 211.

The motor starting capacitor 30 is electrically connected between the main coil 21 and the secondary coil 22 and includes a first end 31 electrically connected to the second main contact 212, and a second end 32 electrically connected to the second secondary contact 222.

The multi-stage switch 40 includes a first rotation speed contact 42, a second rotation speed contact 43 and a third rotation speed contact 44 which are electrically connected to the second main contact 212, a common contact 41, a rotation direction contact 45 electrically connected to the second secondary contact 222, and a conductive member 46 which includes a first conductive end 461 electrically connected to the common contact 41, and a second conductive end 462. The conductive member 46 is electrically connected to the first rotation speed contact 42, the second rotation speed contact 43, the third rotation speed contact 44 or the rotation direction contact 45. The conductive member 46 is located between and does not come into electric contact with the third rotation speed contact 44 and the rotation direction contact 45. In this embodiment, a first variable capacitor 61 is electrically connected between the first rotation speed contact 42 and the second main contact 212, a second variable capacitor 62 which is different in capacitance from the first variable capacitor 61 is electrically connected between the third rotation speed contact 44 and the second main contact 212.

The AC power source 50 includes a first electrode 51 electrically connected to the first main contact 211 and a second electrode 52 electrically connected to the common contact 41.

As shown in FIG. 3, when the user rotates the multi-stage switch 40 so that the second conductive end 462 of the conductive member 46 is located between and does not come into contact with the third rotation speed contact 44 and the rotation direction contact 45, the motor 20 won't start.

As shown in FIG. 4, when the user rotates the multi-stage switch 40 to make the second conductive end 462 of the conductive member 46 electrically connected to the third rotation speed contact 44, the current phase of the secondary coil 22 will be influenced by the motor starting capacitor 30 and fall behind the main coil 21, so that the secondary coil 22 will drive the main coil 21 to rotate the motor 20 in forward direction.

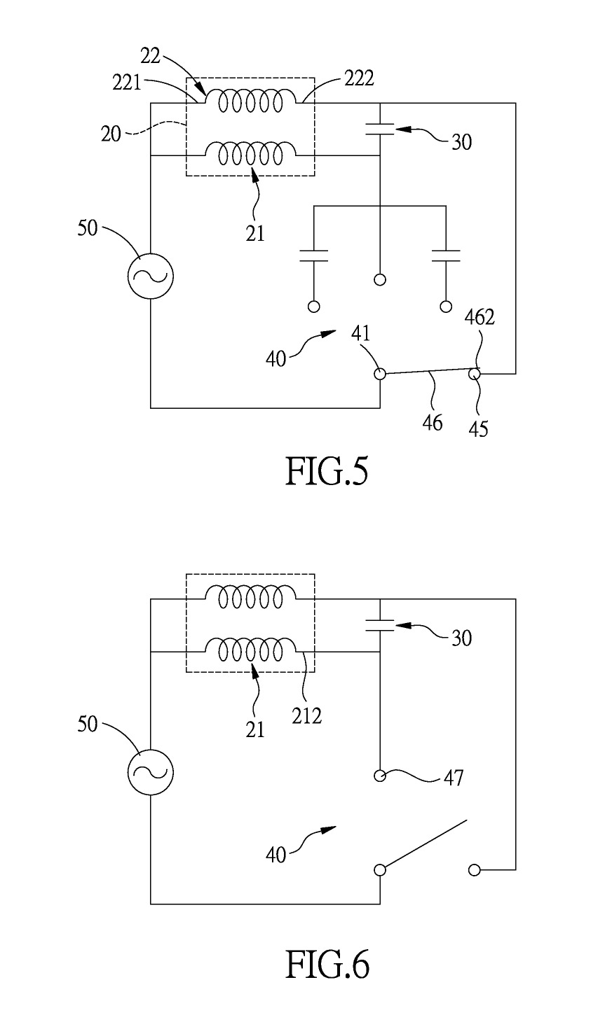

As shown in FIG. 5, when the user rotates the multi-stage switch 40 to make the second conductive end 462 of the conductive member 46 electrically connected to the rotation direction switch 45, the current provided by the AC power source 50 will flow through the common contact 41, the conductive member 46, the rotation direction contact 45 and the second secondary contact 222 and into the secondary coil 22. The main coil 21 is electrically connected to the motor starting capacitor 30, the current phase of the main coil 21 will be influenced by the motor starting capacitor 30 and fall behind the secondary coil 22, so that the main coil 21 will drive the secondary coil 22 to reversely rotate the motor 20.

Therefore, the present invention is capable of controlling the rotation speed and direction simply by using a multi-stage switch 40 (five-stage). As compared with the conventional rotation speed and direction control device, the multi-stage switch 40 of the present invention is structurally similar to the pull switch for controlling the rotation speed, except that the multi-stage switch 40 has one more contact (namely the rotation direction contact 45) than the pull switch. Therefore, the present invention is much structurally simplified since it is capable of controlling rotation speed and direction of the ceiling fan without requiring the use of a rotation direction switch or a remoter controller, therefore, the manufacturing cost and assembly cost of the present invention are decreased.

Referring then to FIG. 6, a ceiling fan motor with a switch device for controlling rotation speed and direction of the ceiling fan motor in accordance with a second embodiment of the present invention is similar to the first embodiment, except that: the multi-stage switch 40 only includes a single rotation speed switch 47 which is electrically connected to the second main contact 212 of the main coil 21, and there is no variable capacitor between the rotation speed switch 47 and the second main contact 212.

While we have shown and described various embodiments in accordance with the present invention, it is clear to those skilled in the art that further embodiments may be made without departing from the scope of the present invention.

What is claimed is:

1. A ceiling fan motor with a switch device for controlling rotation speed and direction of the ceiling fan motor, comprising:
a motor with a main coil and a secondary coil, the main coil including a first main contact and a second main contact, the secondary coil including a first secondary contact and a second secondary contact which are electrically connected to the first main contact;
a motor starting capacitor electrically connected between the main coil and the secondary coil;
a multi-stage switch including a common contact, at least one rotation speed contact electrically connected to the second main contact, a rotation direction contact electrically connected to the second secondary contact, and a conductive member, the conductive member including a first conductive end electrically connected to the common contact, and a second conducive end electrically connected to the rotation speed contact or the rotation direction contact or not electrically connected to the rotation speed contact or the rotation direction contact;
the motor starting capacitor cooperating with the multi-stage switch to control the rotation speed and direction of the ceiling fan.

2. The ceiling fan motor with the switch device for controlling rotation speed and direction of the ceiling fan motor as claimed in claim 1, wherein the multi-stage switch includes three rotation speed contacts electrically connected to the second main contact, between each of two of the three rotation speed contacts and the second main contact is electrically connected a variable capacitor, and the two capacitor are different in capacitance.

3. The ceiling fan motor with the switch device for controlling rotation speed and direction of the ceiling fan motor as claimed in claim 1 further comprises an alternative current power source which has a first electrode electrically connected to the first main contact and a second electrode electrically connected to the common contact.

4. The ceiling fan motor with the switch device for controlling rotation speed and direction of the ceiling fan motor as claimed in claim 2 further comprises an alternative current power source which has a first electrode electrically connected to the first main contact and a second electrode electrically connected to the common contact.
